(19) United States
(12) Patent Application Publication
(10) Pub. No.: US 2008/0175545 A1
(43) Pub. Date: Jul. 24, 2008

(54) Optical Connector Suitable for Field Assembly

(75) Inventors: Wenxin Zheng, Ellicott City, MD (US); Neal Zumovitch, Franklin, TN (US); Brent Ware, Franklin, TN (US)

Correspondence Address: BANNER & WITCOFF, LTD., 1100 13th STREET, N.W., SUITE 1200, WASHINGTON, DC, 20005-4051, US

(73) Assignee: TENVERA, INC., Franklin, TN (US)

(21) Appl. No.: 11/624,515

(22) Filed: Jan. 18, 2007

(51) Int. Cl. G02B 6/36

(52) U.S. Cl. 385/81

(57) ABSTRACT

An illustrative optical connector is disclosed having a first component having a first channel therein and a first screw thread; a second component having a second channel therein and a second screw thread complementary to and engaged with the first screw thread, wherein the first component is at least partially disposed within the second channel; and an optical fiber partially disposed within the first and second channels. Also disclosed is an illustrative kit having connector components and an illustrative method for combining connector components.

### BACKGROUND

Optical connectors are well known and are available in a variety of configurations. For example, a popular type of optical connector is the SC-type of connector. Other common types of optical connectors are the LC, ST, and FC types. However, most optical connectors require sophisticated equipment to properly and accurately assemble the connectors. Moreover, where optical fiber tips are often angled to reduce reflection at the connection point, rotational alignment is an additional factor that makes the assembling of optical connectors a difficult, delicate, and time-consuming process. Because of this, nearly all optical connectors are pre-assembled at the manufacturer's factory and include a short optical fiber pigtail. The consumer, upon receiving the pre-manufactured connector with pigtail, splices the pigtail to the consumer's own optical fiber, such as by fusion splicing.

There have been several problems with this connectorized pigtail approach. For example, proper splicing of optical fibers requires training and extensive practice. Even after proper training, the splicing process itself is slow, which becomes especially important where a large number of connectors need to be added to an optical system. Additionally, a splice inevitably adds some degree of signal loss, and so with every connector there exists at least two sources of signal loss—at the connector and at the splice. Even with proper training by the person creating the splice, splices (especially mechanical splices, which use an index matching gel that degrades after only a year or two) have proven to be unreliable. Still another problem is that the equipment for creating a relatively good quality splice (i.e., the splicer) is expensive. This expense is magnified where multiple workers operate simultaneously such that each worker requires his or her own splicer.

### SUMMARY

In view of the above, an improved optical connector and process for making an optical connection is needed.

The following presents a simplified summary of illustrative aspects in order to provide a basic understanding of various aspects described herein. This summary is not an extensive overview of the invention. It is not intended to identify key or critical elements of the invention or to delineate the scope of the invention. The following summary merely presents various concepts in a simplified form as a prelude to the more detailed description provided below.

For example, aspects provide an optical connector having a first component having a first channel therein and a first screw thread; a second component having a second channel therein and a second screw thread complementary to and engaged with the first screw thread, wherein the first component is at least partially disposed within the second channel; and an optical fiber partially disposed within the first and second channels.

Further aspects provide, for example, a kit containing various ones of the components that make up the connector, as well as a method for combining the components to create the completed connector.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a simplified functional representation of a complementary pair of connectors configured to optically mate with each other.

FIG. 2 is a functional representation of the connectors of FIG. 1 in a mated configuration.

FIG. 3 is a top view of various components of an illustrative connector, including an illustrative tube, spring, ferrule holder, spring holder, lock unit, and connector cover.

FIG. 4 is a detail top view of the tube of FIG. 3.

FIG. 5 is a detail side view of the tube of FIG. 3.

FIG. 6 is a detail top view of the spring holder of FIG. 3.

FIG. 7 is a detail top view of the ferrule holder of FIG. 3.

FIG. 8 is a detail first side view of the ferrule holder of FIG. 3.

FIG. 9 is a detail bottom view of the ferrule holder of FIG. 3.

FIG. 10 is a detail second opposing side view of the ferrule holder of FIG. 3.

FIG. 11 is a detail of view 11-11 of the ferrule holder of FIG. 7.

FIG. 12 is a detail of view 12-12 of the ferrule holder of FIG. 7.

FIG. 13 is a detail top view of the lock unit of FIG. 3.

FIG. 14 is a detail side view of the lock unit of FIG. 3.

FIG. 15 is a detail top view of the connector cover of FIG. 3.

FIG. 16 is a detail side view of the connector cover of FIG. 3.

FIG. 17 is a top cross-sectional view of the combined tube and spring of FIG. 3.

FIG. 18 is a top cross-sectional view of the combined tube, spring, and ferrule holder of FIG. 3, which together form an illustrative spring assembly.

FIG. 19 is a top cross-sectional view of the spring assembly of FIG. 18 and the ferrule holder of FIG. 3.

FIG. 20 is a top cross-sectional view of the spring assembly of FIG. 18, and the ferrule holder and lock unit of FIG. 3.

FIG. 21 is a top cross-sectional view of the spring assembly of FIG. 18, and the ferrule holder, lock unit, and connector cover of FIG. 3.

FIG. 22 is a side cross-sectional view of an illustrative ferrule and ferrule tube.

FIG. 23 is a top view of the combined ferrule and ferrule tube of FIG. 22, which together form an illustrative ferrule assembly.

FIG. 24 is a rear cross-sectional view of the ferrule tube of FIG. 22.

FIG. 25 is a rear cross-sectional view of the combined ferrule and ferrule tube of FIG. 23.

FIG. 26 is a perspective view of the ferrule assembly of FIG. 22, the spring assembly of FIG. 18, and an illustrative boot.

FIGS. 27-29 are each a perspective view of the ferrule assembly of FIG. 22 and the ferrule holder of FIG. 3.

FIG. 30 is an alternative configuration of the assembly of FIG. 29.

FIG. 31 is a perspective view of the ferrule assembly of FIG. 22, the ferrule holder of FIG. 3, and the spring assembly of FIG. 18.

FIG. 32 is a perspective view of the assembly of FIG. 31 and further having the lock unit of FIG. 3.

FIG. 33 is a perspective view of the assembly of FIG. 32 and further having the connector cover of FIG. 3.

FIG. 34 is a flow chart showing illustrative steps that may be performed to assemble the assembly shown in FIGS. 21 and 33.

It is noted that the various drawings are not necessarily to scale.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

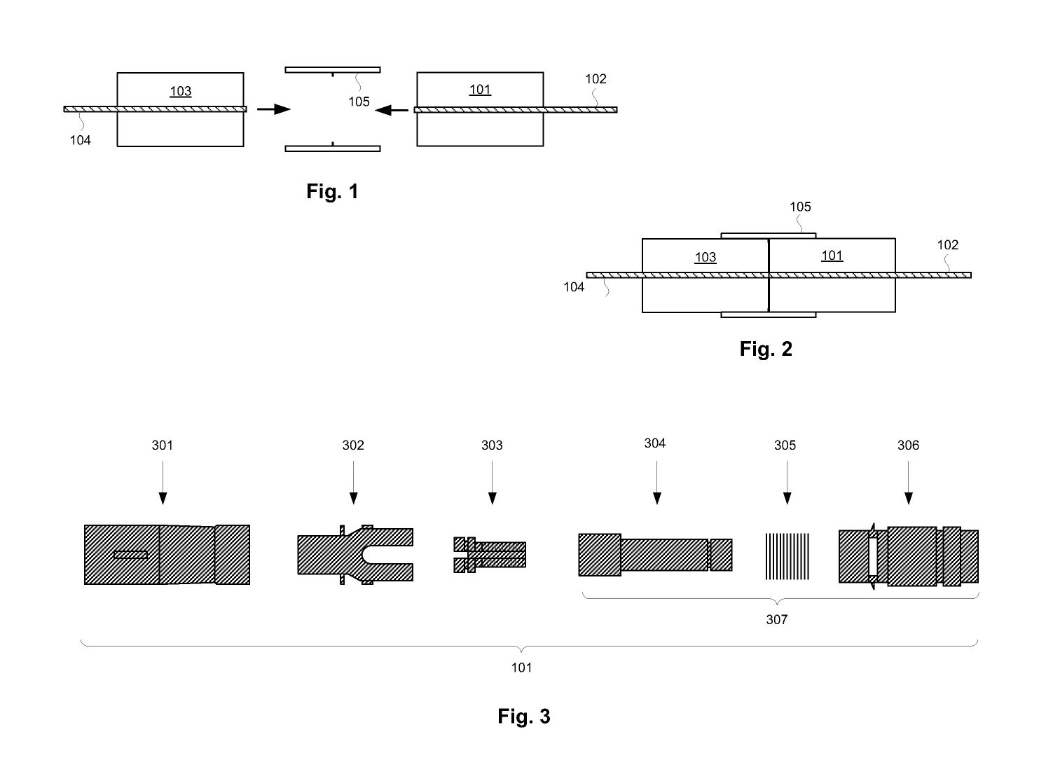

Referring to FIG. 1, a functional diagram shows an illustrative mating pair of optical connectors 101, 103. Each connector 101, 103 has its respective optical pathway for transferring information as modulated light. In the present example, these optical pathways are optical fibers 102, 104. When mated together via an adapter 105 as shown in FIG. 2, the optical pathways are optically coupled together so as to transfer the modulated light from one of the pathways to the other. As illustrated in FIG. 2, when connectors 101 and 103 are properly mated, optical fibers 102 and 104 are brought into contact with each other without an air gap, so as to allow light from one of the optical fibers 102, 104 to transfer into the other one of the optical fibers 102, 104.

The following illustrative embodiments of an optical connector will now be discussed. The connector may be configured so as to be relatively for the end user to easily, quickly, and/or inexpensively add the optical connector to an optical fiber. For instance, the end user may not need a splicer to make the connection, since the connector does not need a pigtail. Thus, the connection may have the potential for contributing less signal loss than do connectorized pigtails, since a splice is no longer needed for each connector. Moreover, the connector may provide for appropriate axial, lateral, and/or rotational alignment of the optical fiber with the optical pathway of the opposing mating connector. Although there exist optical fiber connectors that can be field assembled, these connectors still require fusion splicing or mechanical splicing (with an index-matching gel). In contrast, examples of an optical connector suitable for field assembly will be described in which splicing is unnecessary for creation of the optical connection. Thus, the optical fiber remains intact and may allow for a more reliable and less lossy optical connection. Reliability over a long period of time is important for many applications, especially where the connection may be in a location that is difficult to access after installation, such as within a building wall or underground.

Referring to FIG. 3, a top plan view of a variety of individual components of such an illustrative connector are shown. In this example, connector 101 includes a connector cover 301, a lock unit 302, a ferrule holder 303, a spring holder 304, a spring 305, and a tube 306. When spring holder 304, spring 305, and tube 306 are combined, the resulting combination will be referred to herein as a spring assembly 307. The components are shown in the arrangement in which they are combined in this example. Namely, connector cover 301 is placed over lock unit 302, which in turn is placed over ferrule holder 303 and spring assembly 307. To form spring assembly 307, spring 305 is inserted into tube 306, and spring holder 304 is inserted into spring 305 and tube 306. In addition, ferrule holder 303 is screwed into or otherwise affixed to spring holder 304. The various components 301-307 may be made of any material or combination of materials, such as metal, plastic, and/or ceramic materials.

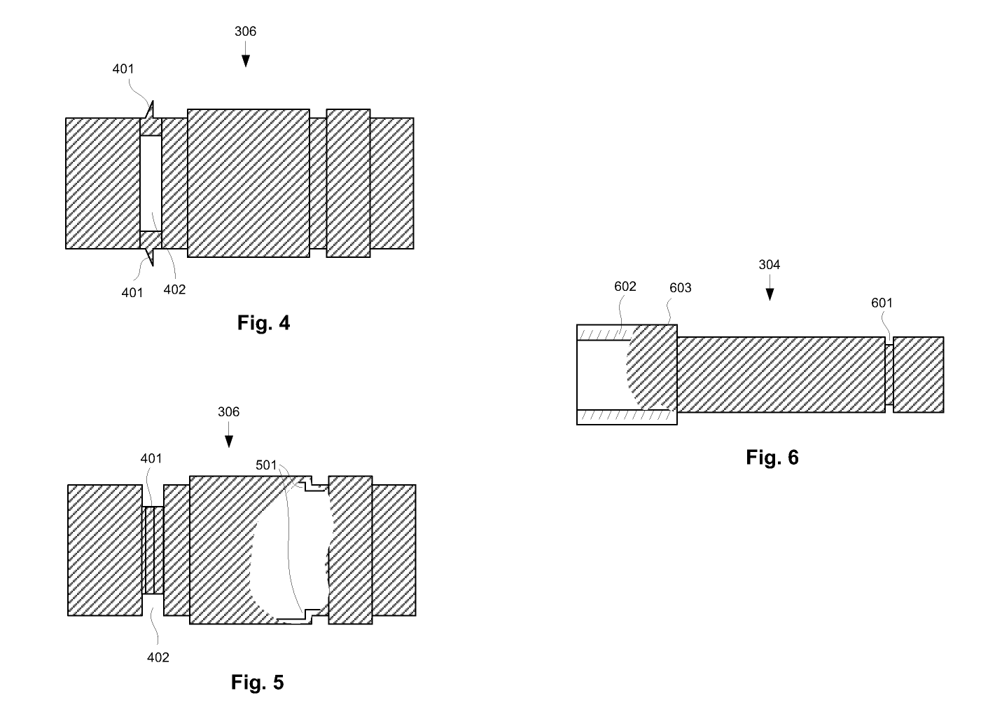

Each of these components 301-307 will be discussed both individually and in conjunction with one another to form an operational connector. FIGS. 4-16 illustrate each component of FIG. 3 in additional detail, with the exception of spring 305. Spring 305 may be a conventional spring. In the shown example, spring 305 is a coiled compression spring, and so a further detailed drawing of spring 305 is unnecessary. However, spring 305 may be another type of spring such as a coiled tension spring or a leaf spring.

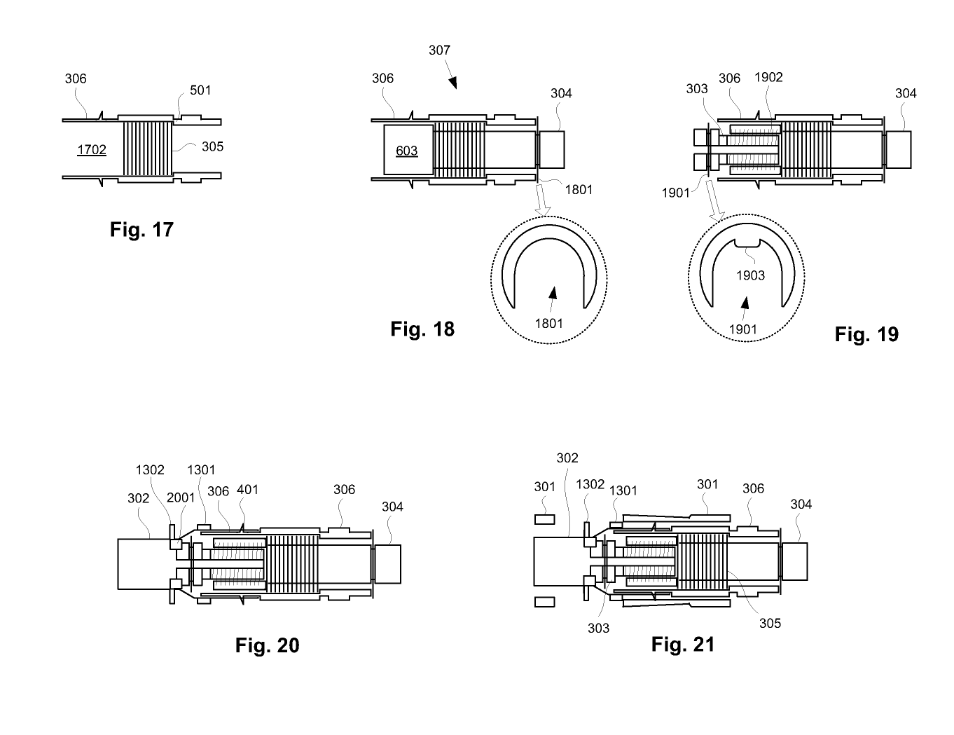

FIGS. 4 and 5 show additional detail of tube 306. FIG. 4 is a top plan view and FIG. 5 is a side view. A purpose of tube 306 is to hold spring 305 and spring holder 304. As shown, tube 306 is generally an elongated hollow cylinder with a hollow enclosed channel 1702 (FIG. 17) extending from end to end along its elongated axis through which optical fiber 102 may be threaded. In addition, tube 306 has a pair of opposed slots 402 and a pair of opposed protruding ears 401. As will be described later, ears 401 are used to affix lock unit 302 to spring assembly 307. In FIG. 5, a portion of the sidewall of tube 306 has been cut away for illustration purposes to expose a portion of the interior of tube 306. As shown, a lip 501 in the form of a step is provided as a stopper against which spring 305 will rest, as will be discussed later. In the present example, lip 501 extends completely around in a circle within an interior portion of tube 306. However, lip 501 may extend only partially around a circle. Also, lip 501 may be embodied as a protruding tab instead of as a step.

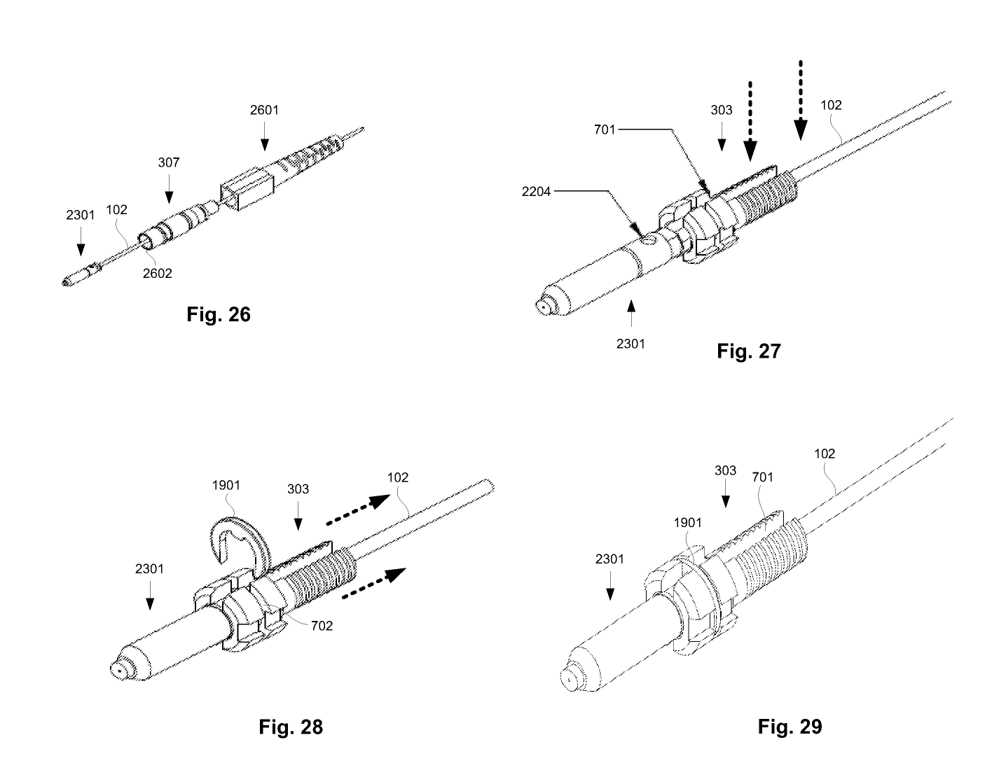

FIG. 6 is a side view of spring holder 304, with a cut-away of a portion showing the interior thereof. As shown, spring holder 304 includes a head portion 603 having a helical interior screw thread 602 for mating with a complementary helical exterior screw thread of ferrule holder 303. Head portion 603 has a larger outer diameter than a remaining portion of spring holder 304. Spring holder 304 has a hollow enclosed channel 2602 (FIG. 26) extending from end to end along its elongated axis through which optical fiber 102 may be threaded. In addition, the exterior of spring holder 304 includes a circular groove 601 thereon for receiving a retaining clip, as will be described later. In the shown embodiment, spring holder 304 is symmetrical about its elongated axis.

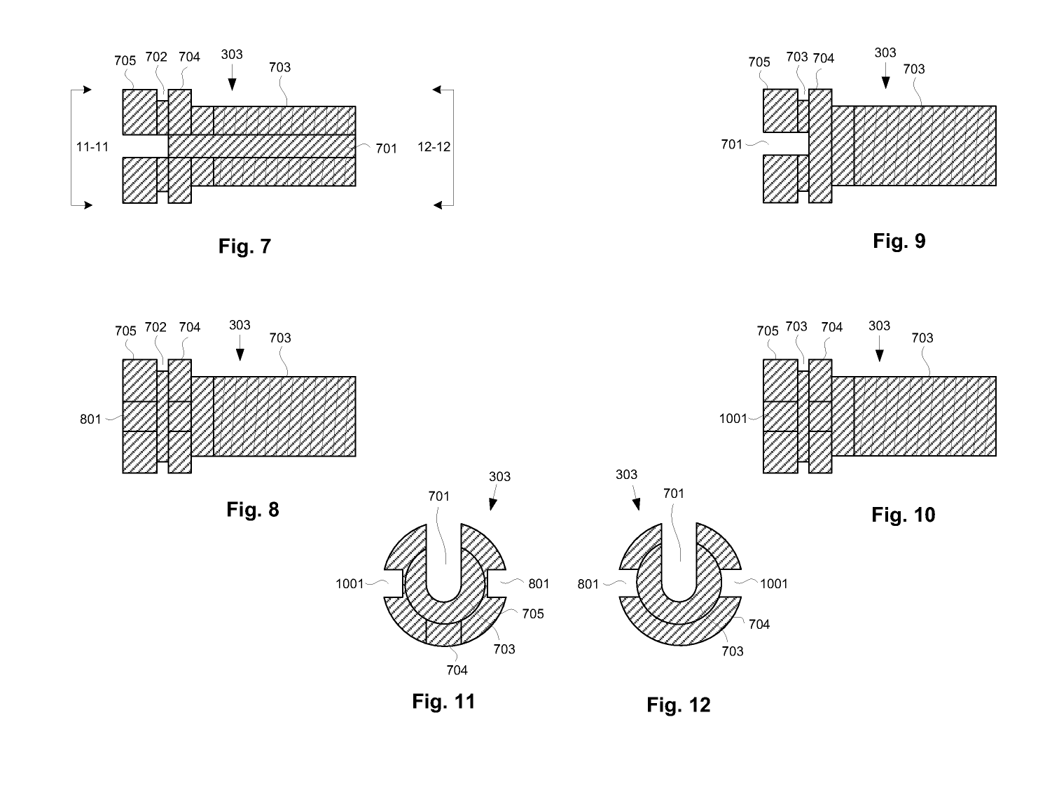

FIGS. 7-12 show various views of ferrule holder 303. In particular, FIG. 7 is a top plan view, FIGS. 8 and 10 are opposing side views, FIG. 9 is a bottom view, FIG. 11 is an end view as indicated by 11-11 in FIG. 7, and FIG. 12 is an opposite end view as indicated by 12-12 in FIG. 7. As shown, ferrule holder 303 is formed as an elongated cylinder having a hollow U-shaped channel 701 that is exposed on one side (in this example, exposed at the top side as shown in FIG. 7). Channel 701 is exposed so that optical fiber 102 may be placed into channel 701 through the exposed side without the need for threading optical fiber 102 lengthwise through channel 701. This is because at least a portion of channel 701 is sufficiently narrow to prevent a ferrule (discussed below) at the end of optical fiber 102 from sliding lengthwise completely through channel 701.

Ferrule holder 303 also has an exterior screw thread 703 that is complementary with and mates to interior screw thread 602 of spring holder 304 by rotating ferrule holder 303 to screw into spring holder 304, in the same manner that a conventional screw is rotated into a nut. Ferrule holder 303 also has a head portion that is made up of an inner flange 704 and an outer flange 705 separated from each other by a circular groove 702. As will be discussed below, groove 702 is configured to receive a retaining clip that affixes the ferrule assembly of optical fiber 102 in all degrees of freedom of motion (e.g., a fixed rotational orientation and longitudinal, i.e., lengthwise, position) relative to ferrule holder 303.

Ferrule holder 303 further includes an opposing pair of notches 801, 1001 in flanges 704 and 705. Notches 801 and 1001 are used to maintain a predetermined rotational alignment of ferrule holder 303 relative to lock unit 302 while still allowing ferrule holder 303 to slide longitudinally in and out of spring assembly 307 against spring 305.

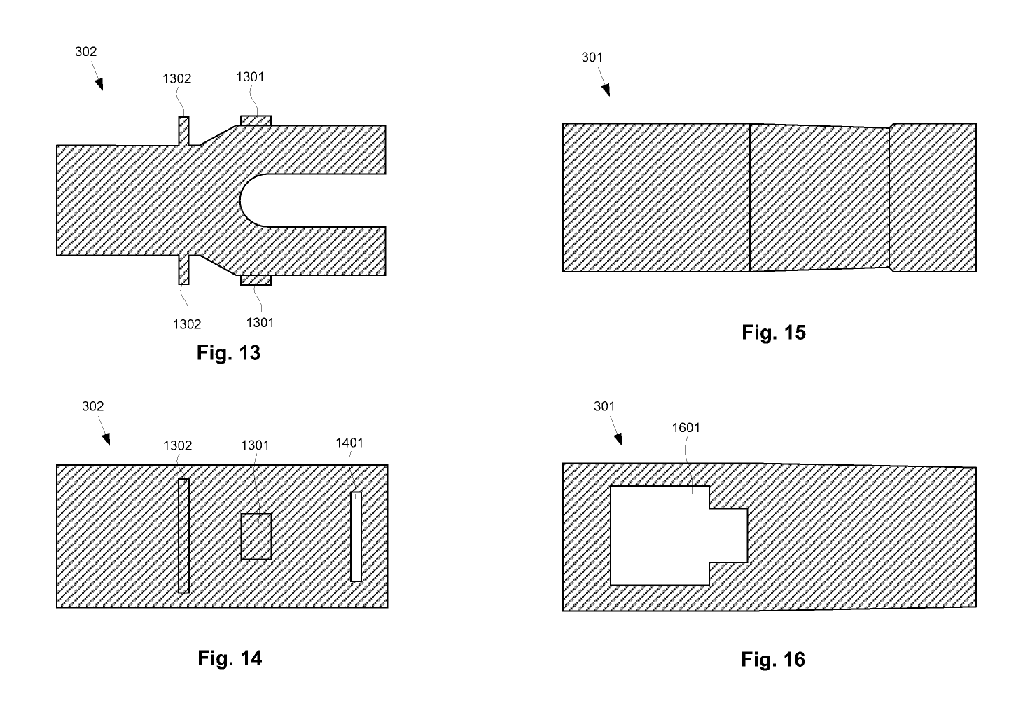

FIGS. 13 and 14 show a top plan view and a side view, respectively, of lock unit 302. As shown, lock unit 302 has a first pair of opposing protruding tabs 1301 and a second pair of opposing protruding tabs 1302. As will be described, tabs 1301 and 1302 are used to affix lock unit 302 to connector cover 301. Lock unit 302 also has a pair of notches 1401 on opposing sides of lock unit 302. These notches 1401 receive ears 401 of tube 306 so as to affix and/or align tube 306 (and thus spring assembly 307) to lock unit 302.

FIGS. 15 and 16 show a top plan view and a side view, respectively, of connector cover 301. As shown, connector cover 301 has a pair of apertures 1601 on opposing sides of lock unit 302. These apertures receive tabs 1301 and 1302 of lock unit 302 so as to affix and/or align lock unit 302 to connector cover 301.

FIGS. 17-21 are top plan views showing various stages of combining the components of connector 101, with selected cut-away details of how certain of the various components fit together. FIG. 17 is a top plan view with a cut-away showing how spring 305 fits within channel 1702 of tube 306. Spring 305 is inserted from the left side aperture of channel 1702 and pushed toward the right until spring 305 rests against lip 501.

Next, referring to FIG. 18, spring holder 304 is inserted from the left side aperture of channel 1702 and pushed toward the right until head portion 603 rests against the left side of spring 305. Thus, spring 305 now encircles the shaft of spring holder 304 between head portion 603 and lip 501. Then, spring holder 304 is pushed further into tube 306 such that spring 305 is under compressive stress, and at that time a retaining clip 1801 is affixed into groove 601 in order to prevent spring holder 304 from slipping out of tube 306 and to maintain the compressive stress. Alternatively, the device could be configured such that when retaining clip 1801 is affixed into groove 601, spring 305 is not under any tension. As shown in the illustrative inset taken from a right-hand point of view in FIG. 18, retaining clip 1801 may be a C-shaped clip that can be slightly stretched open like a spring, which will then snap back to approximately its original shape to fit and remain within groove 601. Alternatively, retaining clip 1801 may hold its current shape such that retaining clip 1801 may be squeezed to fit more tightly within groove 601. In either case, retaining clip 1801 may have an interior radius that is approximately the same as, or slightly larger than, the exterior surface radius of groove 601. Retaining clip 1801 may be made of metal or any other reasonably strong and/or resilient material. The result of connecting these components together results in spring assembly 307, previously referenced.

Next, referring to FIG. 19, ferrule holder 303 is screwed into head portion 603 of spring holder 304. In doing so, exterior screw thread 703 engages with a compatible helical interior screw thread 1902 disposed at the interior surface of head portion 603. As will be discussed later with regard to FIG. 28, another retaining clip 1901 is affixed into groove 702 of ferrule holder 303 to help retain the ferrule assembly of optical fiber 102. Like retaining clip 1801, retaining clip 1901 may be generally C-shaped and made of a material that can be slightly stretched open like a spring, which will then snap back to approximately its original shape to fit and remain within groove 1901. Alternatively, retaining clip 1901 may retain its current shape and may be squeezed to as to fit more tightly within groove 1901. In either case, retaining clip 1901 may have an interior radius that is approximately the same as, or slightly larger than, the exterior surface radius of groove 701. In addition, as will be discussed further with regard to FIG. 28, retaining clip 1901 may have a tab 1903 or other protrusion that couples with a complementary depression in the ferrule assembly of optical fiber 102, to help retain rotational orientation of the ferrule assembly.

Next, referring to FIG. 20, spring assembly 307 plus ferrule holder 303 is inserted into lock unit 302. As previously described, each of ears 401 of tube 306 fit into respective opposing notches 1401 of lock unit 302 to affix lock unit 302 and spring assembly 307 together. In addition, lock unit 302 includes a pair of opposing tabs 2001 on its interior surface that fit into notches 801 and 1001, respectively, of ferrule holder 303. This helps to ensure a fixed rotational orientation of ferrule holder 303 with respect to lock unit 302.

Next, referring to FIG. 21, the entire assembly of FIG. 20 is inserted into connector cover 301. As previously described, tabs 1301 and 1302 of lock unit 302 fit into respective opposing apertures 1601 to help affix lock unit 302 to connector cover 301. Thus, FIG. 21 shows illustrative completed connector 101, except for optical fiber 102 and its ferrule assembly.

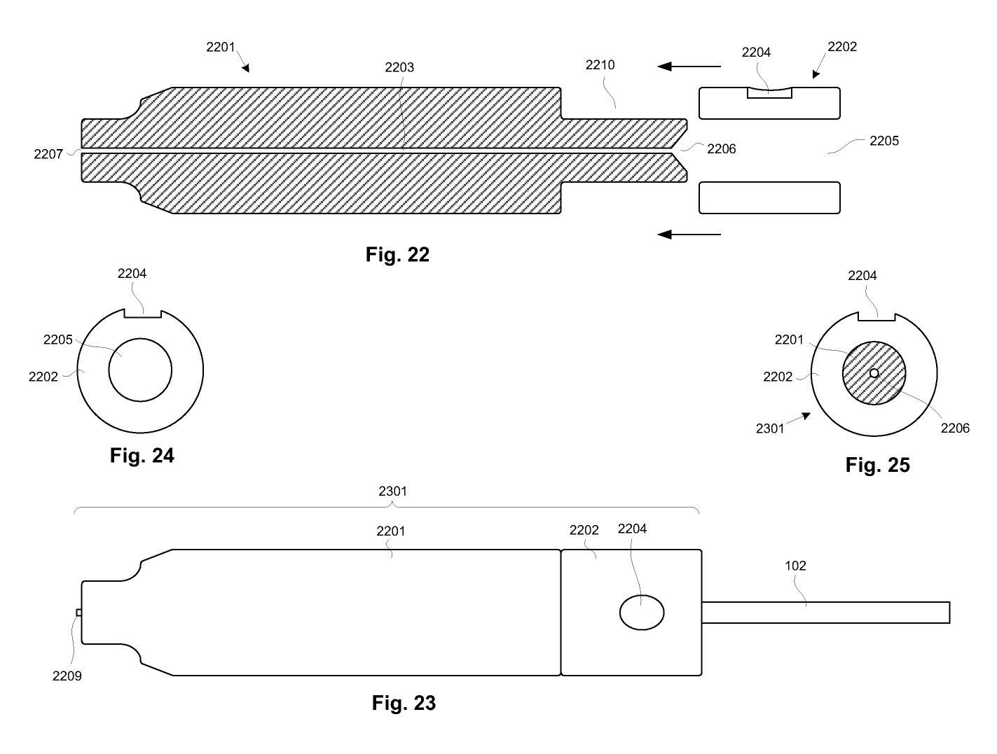

FIG. 22 shows a side cross-sectional view of an illustrative ferrule 2201 and ferrule tube 2202 that together make up the ferrule assembly of optical fiber 102. Ferrule 2201 has a generally elongated shape and has a hollow channel 2203 extending completely through ferrule 2201 along its lengthwise axis from a first aperture 2206 to a second opposite aperture 2207. Channel 2203 is configured such that optical fiber 102 may be threaded through channel 2203 (albeit it may be a stripped version of optical fiber 102, i.e., stripped of its protective covering, that passes through channel 2203). In passing optical fiber 102 through channel 2203, a glue or other adhesive may be added to the interior surface of channel 2203 and/or the exterior surface of optical fiber 102 to affix optical fiber 102 to ferrule 2201.

Ferrule 2201 further has a narrower portion 2210 for receiving ferrule tube 2202. This narrower portion 2210 is configured such that when put together, ferrule 2201 and ferrule tube 2202 form a single approximately flush exterior cylindrical surface, as shown in FIG. 23. Together, ferrule 2201 and ferrule tube 2202 form a ferrule assembly 2301. As further shown in FIGS. 22, 24 and 25, ferrule tube 2202 has a hollow aperture 2205 for receiving narrower portion 2210 of ferrule 2201. In addition, ferrule tube 2202 has a notch, hole, or other depression 2204 for receiving tab 1903 of retaining clip 1901. A glue or other adhesive may be applied on the surface of narrower portion 2210 and/or the interior surface of channel 2205 to affix ferrule 2201 and ferrule 2202 together.

After optical fiber 102 is affixed to ferrule assembly 2301, the tip 2209 of optical fiber 102 is cut and polished as in conventional ferrule assemblies. In addition, tip 2209 may be cut at an angle to the lengthwise axis of optical fiber 102 and ferrule assembly 2301, so as to reduce potential signal reflection. Such angular tips are known in the art. The rotational orientation of the angled surface of tip 2209 about the longitudinal axis of optical fiber 102 may be set at a particular orientation depending upon the rotational position of depression 2204. Put another way, depression 2204 may be used as a point of reference for cutting the angled surface of tip 2209.

Ferrule tube 2202 and ferrule 2201 may be made of the same materials or of different materials than each other. For instance, ferrule 2201 may be made of a ceramic or plastic, while ferrule tube 2202 may be made of a metal. Where ferrule 2201 is made of ceramic, it may be easier to control precise dimensions, such as concentricity, than where ferrule 2201 is made of metal or other materials. It is expected, for instance, that manufacturing a ceramic ferrule 2201 versus a metal ferrule 2201 may result in as much as a ten-fold reduction in fiber-to-ferrule concentricity errors. Such a reduction in concentricity errors, in turn, is expected to reduce connection losses considerably, especially where connector 101 is connected to a standard SC-type connector or other connector where optical fiber 102 must precisely align with optical fiber 104.

As previously mentioned, when depression 2204 receives tab 1903, this allows ferrule assembly 2301 (and thus optical fiber 201) to be fixed in a particular rotational orientation relative to ferrule holder 303 (and indeed to the entire connector 101, since ferrule holder 303 is rotationally fixed relative to spring assembly 307, lock unit 302, and connector cover 301).

In practice, spring assembly 307 may already be pre-assembled by the time it reaches the end user. Thus, the end user may need only to attach ferrule holder 303, retaining clip 1901, lock unit 302, connector cover 301, optical fiber 102, and ferrule assembly 2301 together to form connector 101. In such a case, a kit may be sold or otherwise provided that includes at least one of each of the following components: spring assembly 307, ferrule holder 303, retaining clip 1901, lock unit 302, and connector cover 301, ferrule 2201, and ferrule tube 2202. However, other kits may provide any sub-combination of these items (i.e., leave out one or more of these listed items). The kit may also include written instructions for assembling connector 101 from the included components.

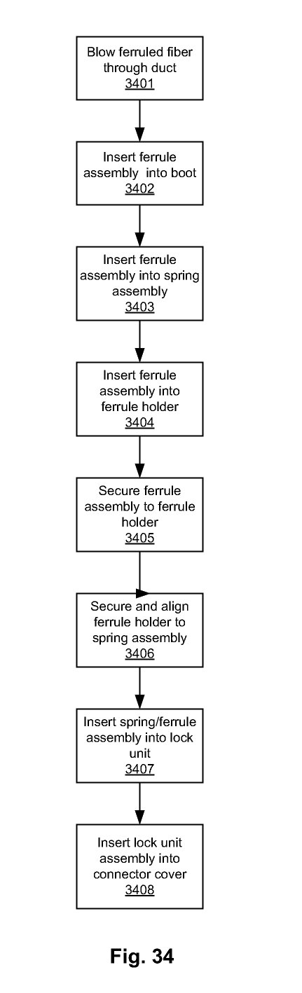

An illustrative method for assembling connector 101 from provided spring assembly 307 is now described in connection with the perspective views of FIGS. 26-33 and the flow chart of FIG. 34. This method may also be described, in whole or in part, by the written instructions in the above-mentioned kit.

First, ferrule assembly 2301 is created and added to optical fiber 102 as previously described in connection with FIGS. 22-25. Next, optical fiber 102 with ferrule assembly 2301 may be blown with an air gun and/or pushed through a duct, such as a narrow conduit (step 3401). Examples of how a ferruled optical fiber may be blown in this manner are described in U.S. patent application Ser. No. 11/551,098, filed Oct. 19, 2006, which is incorporated by reference herein as to its entirety. Alternatively, ferrule assembly 2301 may be created and added to optical fiber 102 after placement of optical fiber 102 in a duct, cable tray, or other desired location.

Next, referring to FIGS. 26 and 34, ferrule assembly 2301 is threaded through a flexible boot 2601 (step 3402). Boot 2601 may be made of any material, such as rubber or plastic, and helps to spread out bending stresses imposed on optical fiber 102 to avoid damage to optical fiber 102. Next, ferrule assembly 2301 is threaded through spring assembly 307 (step 3403). FIG. 26 thus shows the state of assembly after steps 3402 and 3403 have been performed.

Next, ferrule assembly 2301 is inserted into ferrule holder 303 (step 3404), as shown in FIG. 27. To do this, optical fiber 102 is slid laterally into channel 701 in the direction of the broken arrows in FIG. 27. Then, optical fiber 102 is pulled in a backward direction (as indicated by the broken arrows in FIG. 28), and/or ferrule assembly 2301 is pushed in that direction, such that ferrule assembly 2301 seats into ferrule holder 303 as shown in FIG. 28. At this point, depression 2204 of ferrule assembly 2301 should face toward the aperture of channel 701 to receive tab 1903 of retaining clip 1901. Thus, as shown in FIG. 29, retaining clip 1901 is stretched to fit around groove 702 of ferrule holder 303 and to insert tab 1903 into depression 2204. The fitting of tab 1903 into depression 2204 helps to affix ferrule assembly 2301 to ferrule holder 303 (step 3405), by substantially reducing or even preventing forward/backward motion and rotational motion of ferrule assembly 2301 relative to ferrule holder 303.

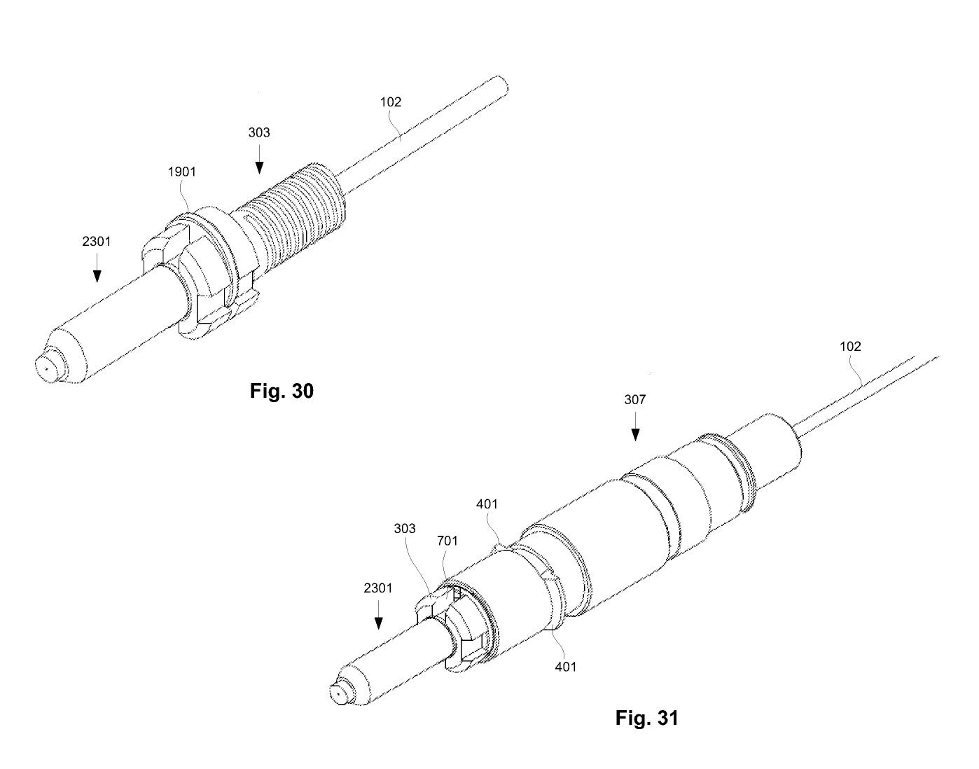

As shown in FIGS. 27-29, depression 2204 and tab 1903 are both rotationally aligned with the open side of channel 701 of ferrule holder 303. However, alternatively depression 2204 and tab 1901 may be rotationally aligned at a point that is 180 degrees opposite the open side of channel 701, such as shown in FIG. 30. This may allow optical fiber 102 to be slid laterally into channel 701 after retainer clip 1901 is already placed around groove 702, since the open end of C-shaped retainer clip 1901 may be aligned with the open end of channel 701. Thus, optical fiber 102 may be slid laterally into channel 701 while passing through the open end of retainer clip 1901. This may further allow ferrule holder 303 to already have retainer clip 1901 loosely disposed in groove 702 when it is provided to the end user, thereby reducing the number of steps needed to be taken by the end user. In such a case, the end user need only squeeze retainer clip 1901 more tightly into groove 702 in order to engage tab 1903 with depression 2204.

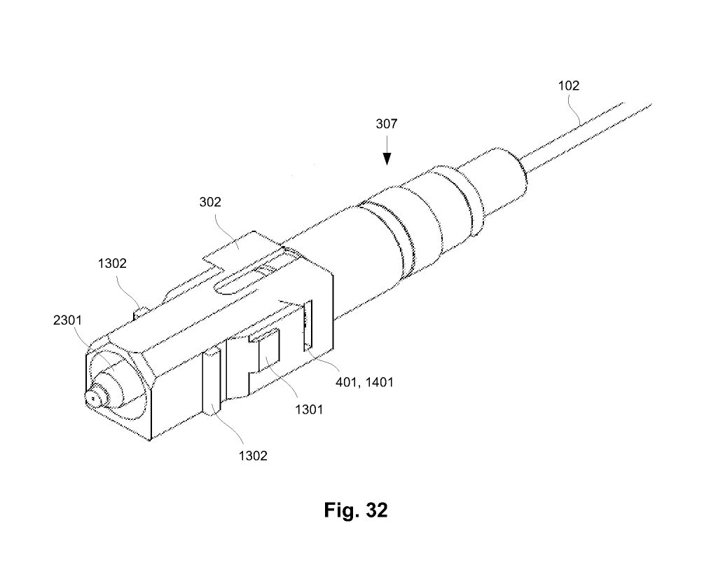

Regardless of whether the assembly of FIG. 29 or FIG. 30 is produced, ferrule holder 303 and spring assembly 307 are next screwed together using complementary screw threads 602 and 703, as shown in FIGS. 31 and 34 (step 3406). In addition, ferrule holder 303 and spring holder 304 are rotated together within tube 306 such that the open side of channel 701 faces orthogonally from ears 401, as shown in FIG. 31. This will allow for ears 401 of tube 306 to properly fit within respective notches 1401 of lock unit 302, while also allowing for tabs 2001 of lock unit 302 to fit within respective notches 801, 1001 of ferrule holder 303 (step 3407), as shown in FIGS. 20 and 32.

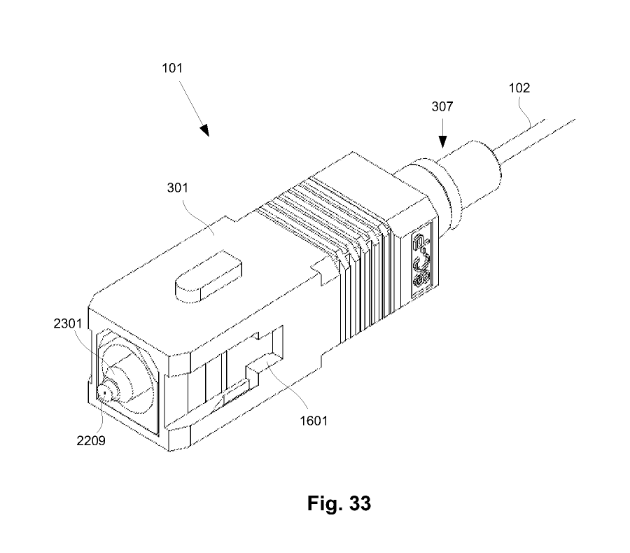

Next, the lock unit assembly of FIG. 32 is inserted into connector cover 301, as shown in FIG. 33 (step 3408). When properly fitted in this example, tabs 1301 and 1302 of lock unit 302 fit in respective opposing apertures 1601 of connector cover 301. Upon completion of this step, illustrative connector 101 has successfully been created and is ready for plugging in to another connector.

Thus, illustrative embodiments of a connector have been described that are practical for assembly in the field, such as by the end user. The described connector may be easier, faster, and cheaper to assemble than creating a conventional fusion splice, and/or more reliable than a conventional mechanical splice. Although the embodiments shown in the drawings are illustratively directed to a SC-P type optical connector that optically connects to another SC-P type optical connector such as connector 103, aspects of the invention as described herein apply to other types of optical connectors, with minor modifications for doing so being readily apparent to one of ordinary skill in the relevant art after having the benefit of reading the present disclosure.

1. An optical connector at an end of an optical fiber, comprising:
a first component having a first channel therein and a first screw thread;
a second component having a second channel therein and a second screw thread complementary to and engaged with the first screw thread, wherein the first component is at least partially disposed within the second channel;
an optical fiber partially disposed within the first and second channels; and
a retaining clip having a protrusion extending radially inward toward a center of the retaining clip, the retaining clip being disposed around the first component, wherein the ferrule assembly includes a depression, the protrusion being at least partially disposed with the depression.

2. The optical connector of claim 1, further including a third component having a third channel therein, wherein the first and second components are at least partially disposed within the third channel.

3. The optical connector of claim 2, further including a spring disposed within the third channel between the second and third components.

4. The optical connector of claim 1, further including a ferrule assembly connected to the end of the optical fiber, the ferrule assembly being at least partially disposed within the first channel.

5. (canceled)

6. The optical connector of claim 1, wherein the first channel is U-channel.

7. The optical connector of claim 1, wherein the optical connector is configured as a SC-P type optical connector.

8. A kit, comprising:
a first component having a first channel therein and a first screw thread;
a second component having a second channel therein and a second screw thread complementary to the first screw thread;
a third component having a third channel therein of a diameter sufficient to receive the second component;
a spring;
a ferrule having a depression therein;
a first retaining clip having a protrusion of a size that at least partially fits within the depression; and
a fourth component having a fourth channel therein and having an aperture in a wall of the fourth channel, wherein the third component has a protrusion that extends into the aperture when the third component is inserted into the fourth channel.

9. (canceled)

10. A kit, comprising:
a first component having a first channel therein and a first screw thread;
a second component having a second channel therein and a second screw thread complementary to the first screw thread;
a third component having a third channel therein of a diameter sufficient to receive the second component;
a spring;
a ferrule having a depression therein; and
a first retaining clip having a protrusion of a size that at least partiallyfits within the depression,
wherein the second component is fully disposed within the third channel and the spring is disposed between the second and third components.

11. A kit comprising:
a first component having a first channel therein and a first screw thread;
a second component having a second channel therein and a second screw thread complementary to the first screw thread;
a third component having a third channel therein of a diameter sufficient to receive the second component;
a spring;
a ferrule having a depression therein;
a first retaining clip having a protrusion of a size that at least partially fits within the depression; and
a second retaining clip connected to the second component such that the spring is under compressive tension,
wherein the second component is fully disposed within the third channel and the spring is disposed between the second and third components.

12. The kit of claim 8, further including a set of written instructions describing how the ferrule, the first retaining clip, the first component, and the second component are assembled together.

13. A method of assembling an optical connector, comprising:
placing an optical fiber within a first channel of a first component;
placing the optical fiber within a second channel of a second component while the optical fiber remains within the first channel, wherein the second channel is an elongated U-channel extending between opposing first and second end openings in the second component and having a continuous lengthwise elongated slip in the second component connecting the first and second end openings, said placing of the optical fiber within the second channel being performed by sliding the optical fiber laterally through the lengthwise slit;
placing a ferrule within the second channel of the second component while the optical fiber remains within the first channel, the ferrule being connected to the optical fiber;
attaching the ferrule to the second component such that the ferrule and the second component are rotationally fixed with respect to each other; and
attaching the first component to the second component while the optical fiber remains within the first channel and the ferrule remains within the second channel.

14. (canceled)

15. The method of claim 13, wherein attaching the first component to the second component includes screwing the first component and the second component together.

16. The method of claim 13, wherein attaching the ferrule to the second component includes attaching the ferrule to the second component such that they are fixed with respect to each other in all degrees of freedom of motion.

17. The method of claim 16, wherein attaching the ferrule includes attaching a retaining clip to the second component such that a protrusion in the retaining clip extends through the lengthwise slip and physically contacts the ferrule.

18. The method of claim 13, wherein the ferrule includes a depression, and wherein the method further includes determining a rotational orientation of a tip of the optical fiber depending upon a rotational position of the depression, and cutting the tip to have the determined rotational orientation.

19. The method of claim 13, further including attaching a third component to the first and second components such that the first and second components are rotationally fixed with respect to the third component, and such that the first and second components are at least partially disposed within the third component.

20. The method of claim 19, further including attaching a fourth component to the third component such that the third component is rotationally fixed with respect to the fourth component.
